(19) United States
(12) Patent Application Publication
(10) Pub. No.: US 2023/0025014 A1
(43) Pub. Date: Jan. 26, 2023

(54) Grill with Height-Adjustable Cooking Surface

(71) Applicant: Stephen R. PERRY, II, Farwell, TX (US)

(72) Inventor: Stephen R. PERRY, II, Farwell, TX (US)

(21) Appl. No.: 17/384,451

(22) Filed: Jul. 23, 2021

(51) Int. Cl. A47J 37/07; F24B 1/00

(52) U.S. Cl. CPC A47J 37/0786; A47J 37/0704; F24B 1/003; A47J 2037/0795

(57) ABSTRACT

A grill with at least one height-adjustable grilling surface is disclosed. The grill body has a fuel burning compartment and a cooking surface that can be easily moved toward and away from any burning fuel in the compartment. The height adjustment mechanism can be a rack and pinion system, with the rack attached to the cooking surface and the pinion actuated by a wheel located outside of the grill body.

### CROSS REFERENCE TO RELATED APPLICATION

None.

### BACKGROUND OF THE INVENTION

### Technical Field

The present invention relates to a grill for cooking food that has a cooking rack that is adjustable such that the rack can be moved towards and away from the cooking fuel.

### SUMMARY OF THE INVENTION

In one embodiment, a grill comprises a grill body comprising a stationary fuel burning compartment below at least one cooking surface, wherein a height between the stationary fuel burning compartment and the cooking surface is adjustable by moving the cooking surface toward or away from the stationary fuel burning compartment. In another embodiment, the grill includes a rack and pinion height adjustment mechanism, wherein the rack is attached to the grill surface and the pinion is connected to a wheel external to the grill body. In another embodiment, the grill includes a vertical rack guide channel inside the grill body. In another embodiment, the vertical rack guide channel extends from the fuel burning compartment to a top of the grill body. In another embodiment, the wheel comprises a diameter that is at least five time larger than an outside diameter of the pinion. In another embodiment, the pinion is inside a housing attached to a top of the grill body. In another embodiment, the pinion is connected to the wheel by a shaft. In another embodiment, the shaft extends through a housing attached to a top of the grill body.

In one embodiment, a grill comprises a stationary fuel burning compartment below a grilling surface, and a rack and pinion height adjustment mechanism configured to adjust a height between the grilling surface and the stationary fuel burning compartment, wherein the rack is attached to the grilling surface and the pinion is attached to a wheel outside the grill body by a shaft.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a front perspective view of one embodiment of the present invention.

FIG. 2 is an angled perspective view of one embodiment of the present invention.

FIG. 3 is a zoomed in perspective view of the height adjustment mechanism used in one embodiment of the present invention.

FIG. 4 is an interior perspective view of one embodiment of the present invention.

### DETAILED DESCRIPTION

The present invention relates to a grill that comprises a grill body with a fuel burning compartment and a cooking surface that is height-adjustable toward and away from any fuel burning in the fuel burning compartment.

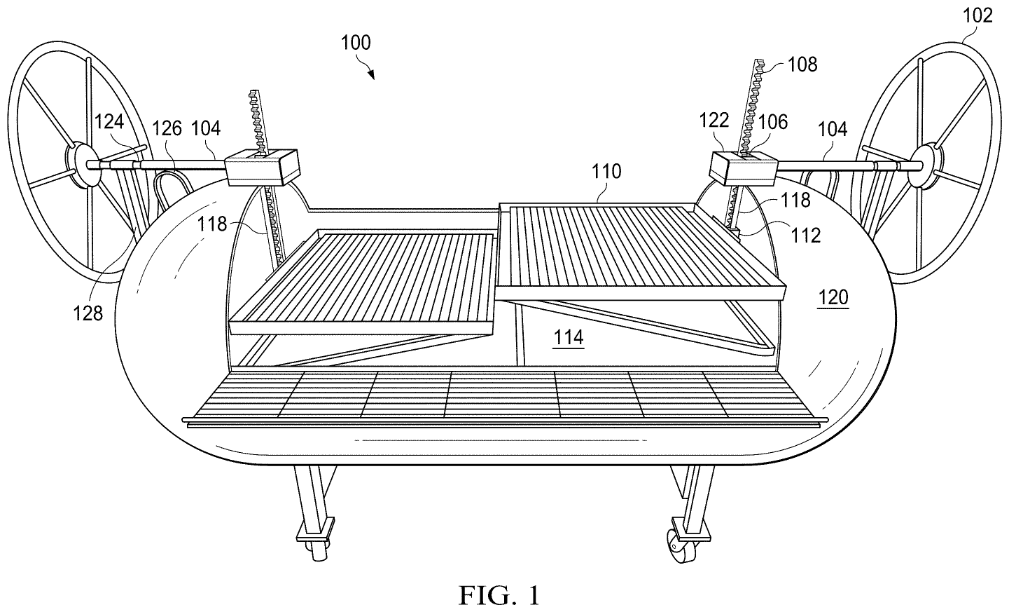

FIG. 1 depicts one embodiment of a grill 100 of the present invention. In the embodiment depicted in FIG. 1, the grill 100 comprises a grill body 120 comprising a fuel burning compartment 114 below a cooking surface 110. The cooking surface may be a grate (as shown), a plate with holes, a rotisserie style stake, or other surface used to cook food on a grill. The grill body, cooking surface, and other structural components may be made of any material suitable for use in a high temperature environment used for cooking food. Exemplary materials include iron, steel, stainless steel, aluminum alloys, or ceramics. The grill depicted in FIG. 1 comprises two cooking surfaces that are independently height-adjustable, but in the broadest scope of the invention, the grill may have one or more height-adjustable cooking surfaces.

As depicted in FIG. 1, the cooking surface is height-adjustable using a rack and pinion height adjustment mechanism. The rack 108 is attached to the cooking surface at attachment 112. Attachment 112 can be a weld, a bolt, a screw, or other attachment mechanism that is strong enough to support the weight of the cooking surface and any food contained on it during height adjustment movement, and to withstand the heat of the grill. The rack 108 is shown in vertical orientation and protrudes from the top of the grill body 120.

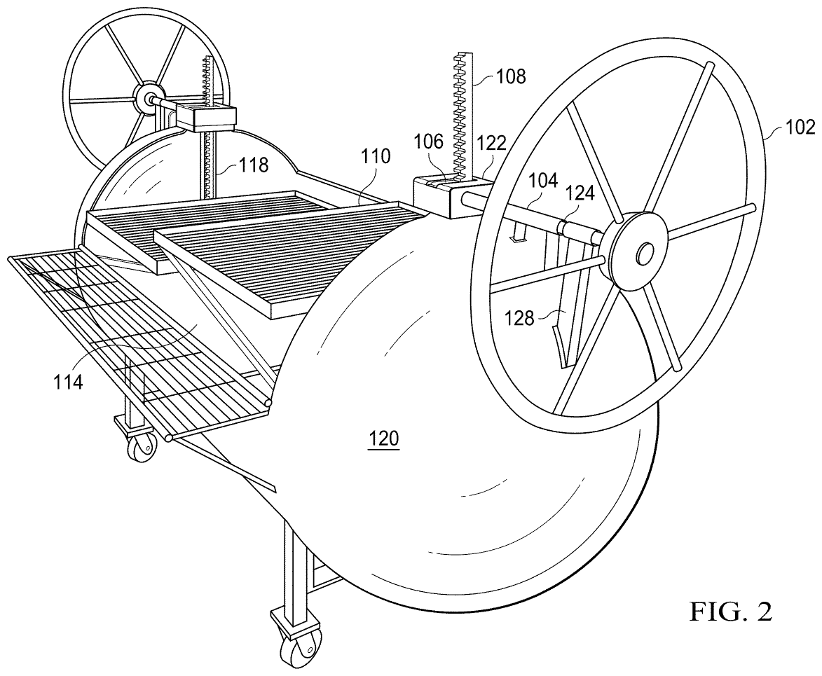

In the embodiment depicted in FIG. 1, the pinion 106 is contained inside a housing 122, and is attached to a wheel 102 that is located outside of the grill body 120. The housing may be attached to the top of the grill body 120 and contain a bearing or shaft that supports the pinion while allowing it to turn along one stationary axis. When the wheel 102 is turned, the pinion 106 also turns in the same direction because the hub of the wheel 102 is connected to the pinion 106 by an actuation shaft 124. In a preferred embodiment, the actuation shaft 124 passes through an outer support shaft 104, which is supported from the grill body by supports 126 and 128. In another embodiment, the actuation shaft is turned by an electric motor instead of the manually actuated wheel 102 shown in FIGS. 1 and 2.

In the embodiment in FIG. 1, a rack guide channel 118 is also provided to help maintain the rack's vertical orientation during operation of the height adjustment mechanism. Preferably, the rack guide channel 118 extends from the top of the grill body 120 where the rack 108 passes through the housing 122 attached to the top of the grill body 120 vertically down to the fuel burning compartment. The rack guide channel 118 at least partially encloses the portion of the rack 108 inside the grill body 120.

FIG. 2 is a side angled perspective view that more clearly illustrates certain components of the grill embodiment of FIG. 1.

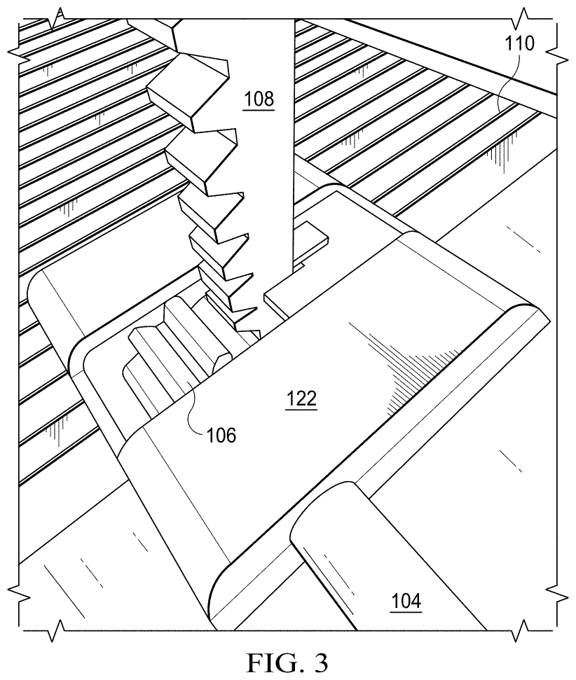

FIG. 3 is a zoomed in perspective view showing how the rack and pinion height adjustment mechanism operates. Pinion 106 is located inside housing 122 and engages with the rack 108 that also passes through the housing. The teeth of the pinion 106 engage with the teeth of the rack 108 such that when the pinion is turned by actuation of the wheel (not shown in this figure) the rack 108 will move up or down according to which direction the wheel is turned. Consequently, cooking surface 110 will also move up or down accordingly.

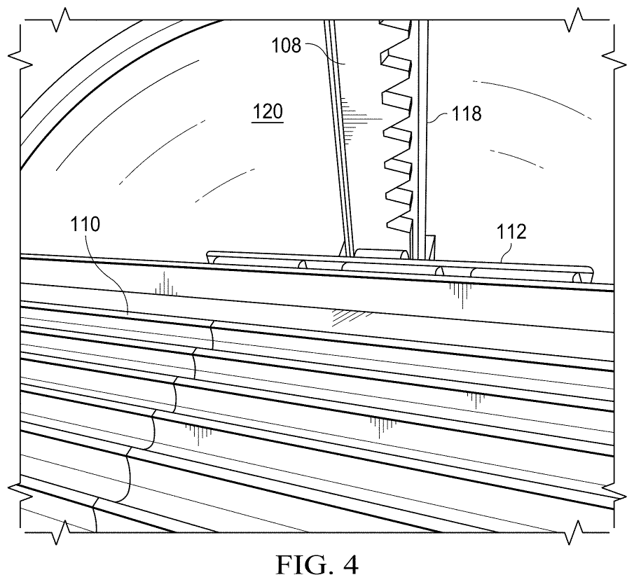

FIG. 4 is an interior perspective view showing the rack 108 attached to cooking surface 110 at attachment 112. FIG. 4 also depicts the rack channel guide 118 that partially encloses the portion of the rack 108 inside the grill body 120.

The grill according to the invention described herein may use any type of fuel typically used to grill food, such as natural gas or propane, pieces of wood, or lump or briquette charcoal.

It will now be evident to those skilled in the art that there has been described herein a grill comprising a grill body having a stationary fuel burning compartment below a cooking surface, wherein the cooking surface is height-adjustable toward and away from the fuel burning compartment. Although the invention hereof has been described by way of preferred embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

In sum, while this invention has been particularly shown and described with reference to a preferred embodiment, it will be understood by those skilled in the art that various changes, in form and detail may be made therein without departing from the spirit and scope of the invention.

1. A grill comprising:
a grill body comprising a stationary fuel burning compartment below at least one cooking surface, wherein a height between the stationary fuel burning compartment and the cooking surface is adjustable by moving the cooking surface toward or away from the stationary fuel burning compartment.

2. The grill of claim 1 comprising a rack and pinion height adjustment mechanism, wherein the rack is attached to the cooking surface and the pinion is connected to a wheel external to the grill body.

3. The grill of claim 2 further comprising a vertical rack guide channel inside the grill body.

4. The grill of claim 3 wherein the vertical rack guide channel extends from the fuel burning compartment to a top of the grill body.

5. The grill of claim 2 wherein the wheel comprises a diameter that is at least five time larger than an outside diameter of the pinion.

6. The grill of claim 2 wherein the pinion is inside a housing attached to a top of the grill body.

7. The grill of claim 2 wherein the pinion is connected to the wheel by a shaft.

8. The grill of claim 7 wherein the shaft extends through a housing attached to a top of the grill body.

9. A grill comprising:
a grill body comprising a stationary fuel burning compartment below a grilling surface;
a rack and pinion height adjustment mechanism configured to adjust a height between the grilling surface and the stationary fuel burning compartment, wherein the rack is attached to the grilling surface and the pinion is attached to a wheel outside the grill body by a shaft.
